(19) United States
(12) Patent Application Publication
(10) Pub. No.: US 2004/0004790 A1
(43) Pub. Date: Jan. 8, 2004

(54) Magnetic disk cartridge and magnetic disk drive

(75) Inventor: Yasushi Endo, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/460,256

(22) Filed: Jun. 13, 2003

(30) Foreign Application Priority Data
Jun. 13, 2002 (JP) 172810/2002

(51) Int. Cl. G11B 23/03

(52) U.S. Cl. 360/133

(57) ABSTRACT

The invention provides a magnetic disk cartridge and associated magnetic disk drive capable of performing high-speed read/write operations on the magnetic disk medium of the cartridge.

The housing of the disk cartridge is provided with two magnetic head insertion sections (openings), one on the left and the other on the right for exposing portions of a magnetic disk medium to permit access to the medium by two magnetic read/write heads of the two read/write sections of the magnetic disk drive, disposed in the corresponding locations to the magnetic head insertion sections. In performing read/write operations on the magnetic disk medium, the two read/write sections perform read/write operations in parallel to increase the data transfer rate.

### BACKGROUND OF THE INVENTION

1. Field of the Invention

The present invention relates to a magnetic disk cartridge having a discoid magnetic disk medium housed in a case, and an associated magnetic disk drive for performing read/write operations on the magnetic disk medium of the cartridge.

2. Description of the Related Art

Flexible disks have conventionally been supplied as a type of magnetic disk medium, which have magnetic layers formed on both sides of a discoid base made of a flexible material, such as a polyester sheet, and signals may be magnetically recorded thereon by the use of a magnetic head.

Generally, the flexible disk is provided in the form of a disk cartridge, which comprises a disk having a rigid center core fitted in its center and is housed in a plastic or metal shell. It is mainly used as a storage medium for computers because of its ease of handling and low cost.

Recently, as the performance of computers has improved with enhanced processing power of their CPU's and increased memory capacity of the main memory, hard disk, etc., it has become commonplace that large data files, such as high quality audio, video, or other similar data files are processed by computers.

It has become typical rather than exceptional in recent years that audio, video, or other similar data files of several to dozens of megabytes (MB) are processed by computers. When such a large file is read or written on a magnetic disk medium, a correspondingly high-speed read or write operation is required.

In fact, in order to reproduce an audio or video signal directly from the magnetic disk medium, the audio or video file needs to be transferred from the magnetic disk medium to the computer at a rate equal to or faster than its bit rate.

As described above, when a large data file is processed by a computer, a high data transfer rate between the magnetic disk cartridge and the computer is required.

### SUMMARY OF THE INVENTION

The present invention has been developed in response to the aforementioned requirements, and it is an object of the present invention to provide a magnetic disk cartridge which allows high-speed read/write operations, and an associated magnetic disk drive.

A magnetic disk cartridge according to the first embodiment of the present invention comprises: a discoid magnetic disk medium; a housing rotatably retaining therein said magnetic disk medium and having a plurality of openings to permit access to said magnetic disk medium by a plurality of magnetic read/write heads of a magnetic disk drive at least simultaneously, each through a corresponding opening of said plurality of openings; and a movable shutter member for opening and closing said plurality of openings, which is moved from a position to close said plurality of openings to a position to open said plurality of openings by a shutter operating member of said drive when said cartridge is inserted therein.

The shutter member of the disk cartridge according to the first embodiment of the present invention described above may be a rotary shutter rotatably retained in the housing with its rotational center substantially aligned with the rotational center of the magnetic disk medium.

Preferably, the rotary shutter has the same number of openings as the housing.

The housing and rotary shutter may be a housing and rotary shutter having a pair of openings respectively.

Preferably, the pair of openings of the housing are provided at places substantially in point symmetrical with respect to the rotational center of the magnetic disk medium.

The magnetic disk cartridge according to the second embodiment of the present invention comprises: a discoid magnetic disk medium; a housing rotatably retaining therein said disk medium and having an opening formed to a size at least to permit access to said magnetic disk medium by a plurarity of magnetic read/write heads of a magnetic disk drive simultaneously; and a movable shutter member for opening and closing said opening, which is moved from a position to close said opening to a position to open said opening by a shutter operating member of said drive when said cartridge is inserted therein.

The shutter member of the disk cartridge according to the second embodiment of the present invention described above may be a rotary shutter rotatably retained in the housing with its rotational center substantially aligned with the rotational center of the magnetic disk medium.

The opening of the housing may be an opening formed to a size to permit access to the magnetic disk medium by two magnetic read/write heads of the magnetic disk drive simultaneously.

Further, the opening of the housing may be an opening formed on the housing having an angle with respect to the rotational center of the magnetic disk medium within an angle range from 135° to less than 180°

Preferably, the rotary shutter has an opening that defines a sector of a circle approximating the discoid magnetic disk medium, and the angle between the radii that defines the sector is substantially the same as that of the opening of the housing.

The magnetic disk drive according to the first embodiment of the present invention is a magnetic disk drive for loading a magnetic disk cartridge of the first embodiment of the present invention described above, and has a plurality of magnetic read/write heads capable of gaining access to the magnetic disk medium at least simultaneously, each through a corresponding opening of the plurality of openings of the housing of the magnetic disk cartridge.

The magnetic disk drive according to the first embodiment of the present invention may be a magnetic disk drive having a pair of magnetic read/write heads, each mounted on each end of a pair of swing arm suspension members which are rotatable along a plane parallel to the surface of the magnetic disk medium with the rotational centers at positions substantially in point symmetrical to each other with respect to the rotational center of the magnetic disk medium.

Further, the pair of suspension members may be a pair of suspension members that rotate in the same direction from the standby positions to permit each of the magnetic read/write heads of each of the pair of suspension members to gain access to the magnetic disk medium.

Preferably, the magnetic disk drive according to the first embodiment of the present invention has a main buffer for temporarily storing data to be transmitted to an external device or received therefrom, and sub-buffers provided for each of the plurality of magnetic read/write heads for temporarily storing data to be transmitted to the main buffer or received therefrom.

The magnetic disk drive according to the second embodiment of the present invention is a disk drive for loading a magnetic disk cartridge of the second embodiment described above, and has a plurality of magnetic read/write heads capable of gaining access to the magnetic disk medium at least simultaneously through the opening of the housing of the magnetic disk cartridge.

The magnetic disk drive according to the second embodiment of the present invention may be a magnetic disk drive having a pair of magnetic read/write heads, each mounted on each end of a pair of swing arm suspension members which are rotatable along a plane parallel to the surface of the magnetic disk medium, and rotate in the same direction, or opposite directions from the standby positions to permit each of said pair of magnetic read/write heads of each of said pair of suspension members to gain access to said magnetic disk medium.

Preferably, the magnetic disk drive according to the second embodiment of the present invention has a main buffer for temporarily storing data to be transmitted to an external device or received therefrom, and sub-buffers provided for each of the plurality of magnetic read/write heads for temporarily storing data to be transmitted to the main buffer or received therefrom.

The magnetic disk cartridge according to the first embodiment of the present invention comprises a housing having a plurality of openings, so that a plurality of magnetic read/write heads of a magnetic disk drive may gain access to the single magnetic disk medium simultaneously, allowing the magnetic disk drive to perform high-speed read/write operations.

The magnetic disk cartridge according to the second embodiment of the present invention comprises a housing having an opening formed to a size to permit access to the magnetic disk medium by a plurality of magnetic read/write heads of a magnetic disk drive simultaneously, so that a plurality of magnetic read/write heads of a magnetic disk drive may gain access to the single magnetic disk medium simultaneously, allowing the magnetic disk drive to perform high-speed read/write operations.

The magnetic disk drives according to the first and second embodiments of the present invention have a plurality of magnetic read/write heads in accordance with the respective magnetic disk cartridges of the first and second embodiments, so that they may perform high-speed read/write operations on the respective magnetic disk cartridges(magnetic disk media).

### BRIEF DESCRIPTION OF THE DRAWINGS

FIG. 1 is a schematic diagram of a magnetic disk cartridge and a magnetic disk drive according to a first embodiment of the present invention.

FIG. 2 is an exploded perspective view of a magnetic disk cartridge according to a first embodiment of the present invention.

FIG. 3 is a schematic diagram of a magnetic disk cartridge and a magnetic disk drive according to a second embodiment of the present invention.

FIG. 4 is a schematic diagram of a magnetic disk cartridge and a magnetic disk drive according to a third embodiment of the present invention.

### DETAILED DESCRIPTION OF THE PREFERRED EMBODIMENTS

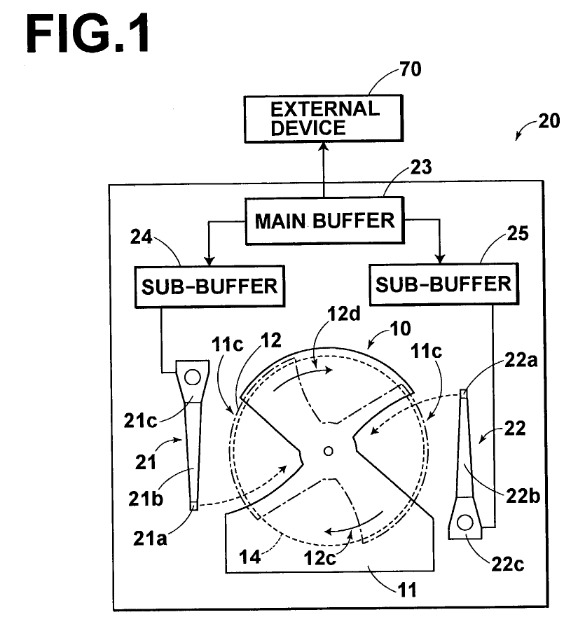

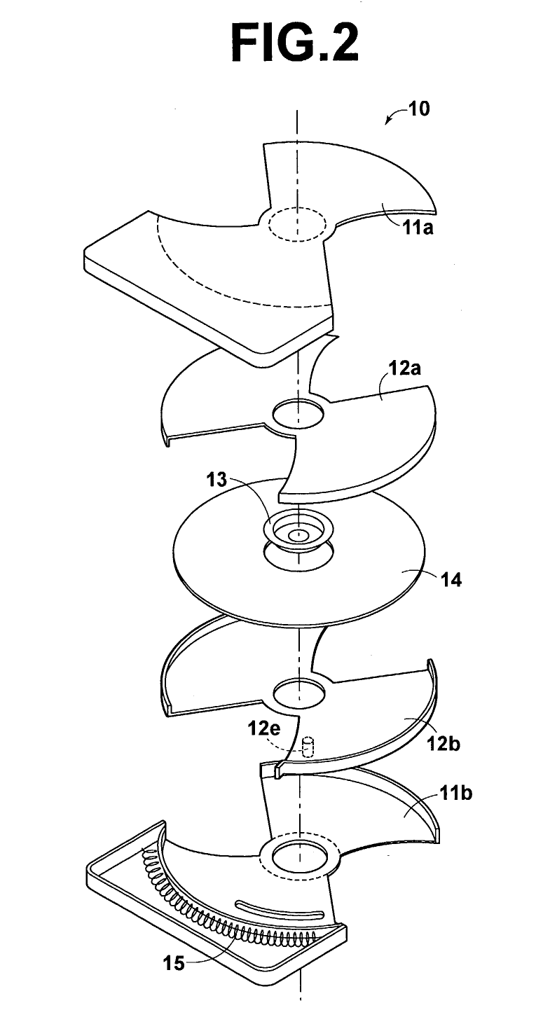

Hereinafter, the present invention will be described further by way of embodiments shown in the accompanying drawings. FIG. 1 is a schematic diagram of a magnetic disk cartridge and a magnetic disk drive according to a first embodiment of the present invention, and FIG. 2 is an exploded perspective view of a magnetic disk cartridge according to a first embodiment of the present invention.

A magnetic disk cartridge 10 comprises: a housing 11 formed by bonding an upper shell 11a and a lower shell 11b together; a shutter member 12 disposed within the housing 11; and a magnetic disk medium 14 which is fixedly held by a center core 13 and is rotatably retained in the housing 11.

The housing 11 has two magnetic head insertion sections 11c and 11d (openings), one on the left and the other on the right, for exposing portions of a magnetic disk medium 14 to permit access to the medium by the magnetic heads of the read/write sections of a magnetic disk drive, which will be described later. Each of the magnetic head insertion sections 11c and 11d is formed along the pathway of suspension members and magnetic heads of respective read/write sections 21 and 22, which will be described later, to permit the magnetic heads to gain access to the magnetic disk medium 14 without interfering with the housing 11.

The shutter member 12 comprises a substantially circular upper part 12a and a substantially circular lower part 12b to sandwich the magnetic disk medium 14 therebetween, and has two openings 12c and 12d associated with the magnetic head insertion sections 11c and 11d of the housing 11. The two magnetic head insertion sections 11c and 11d may be opened and closed by the single shutter member 12. The lower part 12b has a protrusion 12e to engage with a shutter operating member of the magnetic disk drive 20, which will be described later. The shutter member 12 is urged by a spring 15 toward a position to close the magnetic head insertion sections 11c and 11d.

The magnetic disk drive 20 comprises two read/write sections 21 and 22 for performing read/write operations to the discoid magnetic disk medium 14 housed in the magnetic disk cartridge 10; sub-buffers 24 and 25 connected respectively to the read/write sections 21 and 22; a main buffer 23 connected to both of the sub-buffers 24 and 25; and a magnetic disk driving section (not shown) to rotate the magnetic disk medium 14.

Since the first read/write section 21 and the second read/write section 22 are configured identically, only the first read/write section 21 will be described hereinafter. Numerical notations for parts used in the second read/write section 22 which are identical to that used in the first read/write section 21 will be denoted in parentheses.

The first read/write section 21 (the second read/write section 22) comprises a pair of suspension members 21b (22b) and magnetic heads 21a (22a) mounted at the end of the suspension members 21b (22b) for the upper and lower surfaces of the magnetic disk medium 14.

Each of the magnetic heads 21a (22a) has a slider and a thin film magnetic head having a head gap for read/write operations and other components are mounted thereon. The slider is designed to be of a form that generates a floating or an attracting force with respect to the surface of the magnetic disk medium 14 by the air current developed by the rotation of the magnetic disk medium 14. That is, the slider floats above or contacts the surface of the magnetic disk medium 14 accompanying high speed rotation of the medium. The contact force of the magnetic heads 21a (22a) is maintained at a predetermined value by the relationship between the urging force of the suspension members 21b (22b) and the floating or attracting force generated by the slider.

The upper and lower suspension members 21b (22b) are supported by a suspension supporting section 21c (22c). The suspension supporting section 21c (22c) turns from side to side so that the magnetic heads 21a (22a) mounted on the suspension members 21b (22b) may move from the central region, excluding the center core 13, to the outer circumferential region of the magnetic disk medium 14.

The first read/write section 21 is disposed on the left side of the magnetic disk cartridge 10, and turns counter-clockwise from its standby position to gain access to the magnetic disk medium 14. The second read/write section 21 is disposed on the right side of the magnetic disk cartridge 10, and turns counter-clockwise from its standby position, like the first read/write section 21, to gain access to the magnetic disk medium 14.

Respective pairs of the upper and lower magnetic heads 21a and 22a of the first and second read/write sections 21 and 22, configured in the manner described above, contact the surfaces of the magnetic disk medium 14 with the medium being sandwiched by the respective pairs of the magnetic heads 21a and 22a to rotate the medium stably.

The magnetic disk driving section holds the magnetic disk cartridge 10 in place and rotates the magnetic disk medium 14 at a predetermined rotation speed by rotating a spindle and a hub-chuck gripping the center core 13 of the magnetic disk medium 14 by a driving motor (not shown). It also exposes portions of the magnetic disk medium through the magnetic head insertion sections 11c and 11d by engaging a shutter operating member (not shown) with the protrusion 12e of the shutter member 12 and turning it to a position to open the magnetic disk medium insertion sections 11c and 11d in response to the insertion of the magnetic disk cartridge 10 into the magnetic disk drive 20.

When a data file is written on the magnetic disk medium 14 by the magnetic disk drive 20 constructed in the manner described above, the data from an external device 70 is stored in the main buffer 23 in units of a predetermined amount. The data stored in the main buffer 23 is split into halves, which are sent respectively to the first and second sub-buffers 24 and 25. Then, the respective amounts of data stored in the first and second sub-buffers are written on the magnetic disk medium 14 simultaneously through the first and second read/write sections 21 and 22. After the data stored in the main buffer 23 is sent to the first and second sub-buffers, the next unit of a predetermined amount of data is stored in the main buffer 23. Thereafter, this process is repeated until the transfer of the data file is completed.

When a data file is read from the magnetic disk medium 14 by the magnetic disk drive 20, predetermined amounts of data at a time are read from the magnetic disk medium 14 simultaneously through the first and second read/write sections 21 and 22, which are stored respectively in the first and second sub-buffers. When predetermined amounts of data are stored in the first and second sub-buffers, they are sent to the main buffer 23, which in turn are sent to the external device 70. After the data stored in the first and second sub-buffers 24 and 25 are sent to the main buffer 23, the next units of a predetermined amount of data is read through the first and second read/write sections 21 and 22. Thereafter, this process is repeated until the transfer of the data file is completed.

As described above, the magnetic disk drive 20 performs read/write operations in parallel using two read/write sections so that it may double the data transfer rate to/from the magnetic disk medium, requiring approximately half the time compared with an ordinary magnetic disk drive having only a single read/write section.

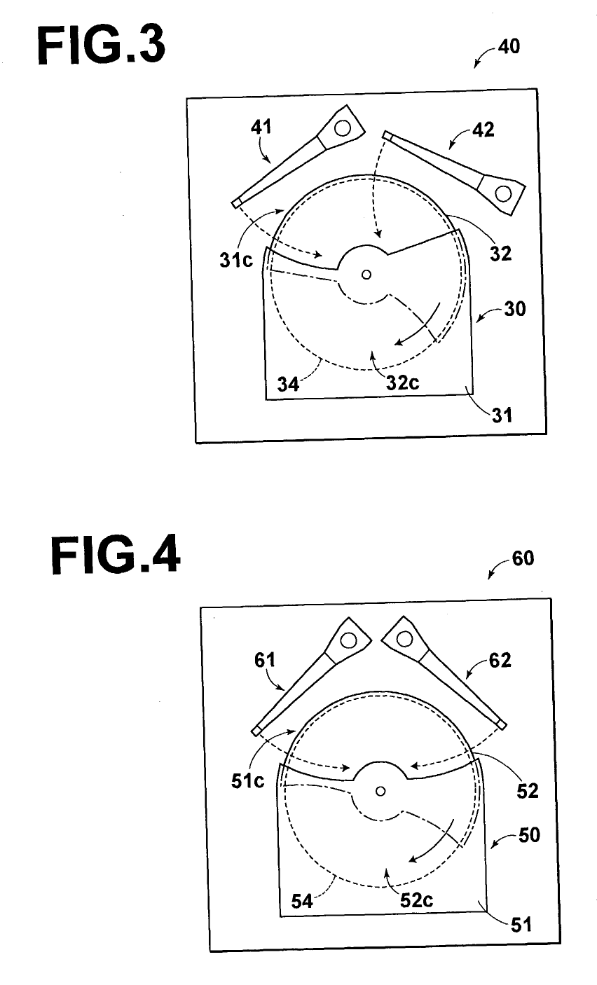

Hereinafter, a second embodiment of the present invention will be described. FIG. 3 is a schematic diagram of a magnetic disk cartridge and a magnetic disk drive according to a second embodiment of the present invention. The main buffer and sub-buffers are omitted in FIG. 3 for simplification.

The magnetic disk cartridge and a magnetic disk drive of the second embodiment of the present invention are similar to those of the first embodiment, but the shape and the number of magnetic head insertion sections (openings) of the cartridge and the locations of the two read/write sections of the drive are different.

A first read/write section 41 and a second read/write section 42 of a magnetic disk drive 40 are disposed respectively on the upper side and upper right of a magnetic disk cartridge 30, and gain access to a magnetic disk medium 34 by both turning counter-clockwise from their standby positions.

A housing 31 of the magnetic disk cartridge 30 has a magnetic head insertion section 31c on the upper side for exposing a portion of the magnetic disk medium 34 to permit access to the medium by the magnetic heads of two read/write sections 41 and 42 of the magnetic disk drive 40. The magnetic head insertion section 31c is formed along the pathways of the suspension members and magnetic heads of the two read/write sections 41 and 42 to permit the magnetic heads to gain access to the magnetic disk medium 34 without interfering with the housing 31.

The magnetic head insertion section 31c is formed on the housing 31 having an angle with respect to the rotational center of the magnetic disk medium 34 within an angle range from 135° to less than 180° to permit access to the magnetic disk medium 34 by two magnetic read/write heads simultaneously.

Also, a shutter member 32 has an opening 32c having the same angle as that of the magnetic head insertion section 31c of the housing 31 in order to be associated with it.

The second embodiment of the present invention provides similar advantages to those provided by the first embodiment.

Hereinafter, a third embodiment of the present invention will be described. FIG. 4 is a schematic diagram of a magnetic disk cartridge and a magnetic disk drive according to a third embodiment of the present invention. The main buffer and sub-buffers are omitted in FIG. 4 for simplification.

The magnetic disk cartridge and a magnetic disk drive of a third embodiment of the present invention are similar to those of the second embodiment, but the shape of the magnetic head insertion section (opening) of the cartridge and the locations of the two read/write sections of the drive are different.

A first read/write section 61 of a magnetic disk drive 60 is disposed on the upper side of a magnetic disk cartridge 50 and gains access to a magnetic disk medium 54 by turning counter-clockwise from its standby position. A second read/write section 62 of the magnetic disk drive 60 is disposed on the upper side of the magnetic disk cartridge 50 and gains access to a magnetic disk medium 54 by turning clockwise from its standby position.

A housing 51 of the magnetic disk cartridge 50 has a magnetic head insertion section 51c on the upper side for exposing a portion of the magnetic disk medium 54 to permit access to the medium by the magnetic heads of two read/write sections of the magnetic disk drive 50. The magnetic head insertion section 51c is formed along the pathways of the suspension members and magnetic heads of the two read/write sections 61 and 62 of the magnetic disk drive 60 to permit the magnetic heads to gain access to the magnetic disk medium 54 without being blocked by the housing 51.

The magnetic head insertion section 51c is formed on the housing 51 having an angle with respect to the rotational center of the magnetic disk medium 54 within an angle range from 135° to less than 180° to permit access to the magnetic disk medium 54 by two magnetic read/write heads simultaneously.

Also, a shutter member 52 has an opening 52c having the same angle as that of the magnetic head insertion section 51c of the housing 51 in order to be associated with it.

The third embodiment of the present invention provides similar advantages to those provided by the first embodiment.

The manner in which two read/write sections to the magnetic disk drive and associated two magnetic head insertion sections to the housing of the magnetic disk cartridge are provided of the present invention are not limited to those described in the above three embodiments.

Three embodiments (first, second and third) of the present invention have been described by way of specific examples in which two read/write sections are provided to the magnetic disk drive and two magnetic head insertion sections associated therewith are also provide to the housing of the magnetic disk cartridge, but the present invention is not limited to the aforementioned examples. Three or more read/write sections, for example, may be provided to a magnetic disk cartridge and three or more magnetic head insertion sections associated therewith may also be provided to the housing of the magnetic disk cartridge.

What is claimed is:

1. A magnetic disk cartridge comprising:
a discoid magnetic disk medium;
a housing rotatably retaining therein said magnetic disk medium and having a plurality of openings to permit access to said magnetic disk medium by a plurality of magnetic read/write heads of a magnetic disk drive at least simultaneously, each through a corresponding opening of said plurality of openings; and
a movable shutter member for opening and closing said plurality of openings, which is moved from a position to close said plurality of openings to a position to open said plurality of openings by a shutter operating member of said drive when said cartridge is inserted therein.

2. A magnetic disk cartridge according to claim 1, wherein said shutter member is a rotary shutter rotatably retained in said housing with its rotational center substantially aligned with the rotational center of said magnetic disk medium.

3. A magnetic disk cartridge according to claim 2, wherein said rotary shutter has the same number of openings as said housing.

4. A magnetic disk cartridge according to claim 3, wherein said housing and said rotary shutter have a pair of openings respectively.

5. A magnetic disk cartridge according to claim 4, wherein said pair of openings of said housing are provided at places substantially in point symmetrical with respect to the rotational center of said magnetic disk medium.

6. A magnetic disk cartridge comprising:
a discoid magnetic disk medium;
a housing rotatably retaining therein said magnetic disk medium and having an opening formed to a size at least to permit access to said magnetic disk medium by a plurality of magnetic read/write heads of a magnetic disk drive simultaneously; and
a movable shutter member for opening and closing said opening, which is moved from a position to close said opening to a position to open said opening by a shutter operating member of said drive when said cartridge is inserted therein.

7. A magnetic disk cartridge according to claim 6, wherein said shutter member is a rotary shutter rotatably retained in said housing with its rotational center substantially aligned with the rotational center of said magnetic disk medium.

8. A magnetic disk cartridge according to claim 7, wherein said opening is formed to a size to permit access to said magnetic disk medium by two magnetic read/write heads of said magnetic disk drive simultaneously.

9. A magnetic disk cartridge according to claim 8, wherein said opening is formed on said housing having an angle with respect to the rotational center of said magnetic disk medium within an angle range from 135° to less than 180°.

10. A magnetic disk cartridge according to claim 9, wherein said rotary shutter has an opening that defines a sector of a circle approximating the discoid magnetic disk medium, and the angle between the radii that defines the sector is substantially the same as that of the opening of the housing.

11. A magnetic disk drive for loading a magnetic disk cartridge of claim 1, wherein said drive comprises a plurality of magnetic read/write heads capable of gaining access to said magnetic disk medium at least simultaneously, each through a corresponding opening of said plurality of openings of said housing of said magnetic disk cartridge.

12. A magnetic disk drive according to claim 11, wherein said drive has a pair of magnetic read/write heads.

13. A magnetic disk drive according to claim 12, wherein each of said pair of magnetic read/write heads is mounted on each end of a pair of swing arm suspension members which are rotatable along a plane parallel to the surface of said magnetic disk medium with the rotational centers at positions substantially in point symmetrical to each other with respect to the rotational center of said magnetic disk medium.

14. A magnetic disk drive according to claim 13, wherein said pair of suspension members rotate in the same direction from the standby positions to permit each of said pair of magnetic read/write heads of each of said pair of suspension members to gain access to said magnetic disk medium.

15. A magnetic disk drive according to claim 11, wherein said drive further comprises:
a main buffer for temporarily storing data to be transmitted to an external device or received therefrom; and
sub-buffers provided for each of said plurality of magnetic read/write heads for temporarily storing data to be transmitted to said main buffer or received therefrom.

16. A magnetic disk drive for loading a magnetic disk cartridge of claim 6, wherein said drive comprises a plurality of magnetic read/write heads capable of gaining access to said magnetic disk medium at least simultaneously through said opening of said housing of said magnetic disk cartridge.

17. A magnetic disk drive according to claim 16, wherein said drive has a pair of magnetic read/write heads.

18. A magnetic disk drive according to claim 17, wherein each of said pair of magnetic read/write heads is mounted on each end of a pair of swing arm suspension members which are rotatable along a plane parallel to the surface of said magnetic disk medium, and rotate in the same direction from the standby positions to permit each of said pair of magnetic read/write heads of each of said pair of suspension members to gain access to said magnetic disk medium.

19. A magnetic disk drive according to claim 17, wherein each of said pair of magnetic read/write heads is mounted on each end of a pair of swing arm suspension members which are rotatable along a plane parallel to the surface of said magnetic disk medium, and rotate in opposite directions from the standby positions to permit each of said pair of magnetic read/write heads of each of said pair of suspension members to gain access to said magnetic disk medium.

20. A magnetic disk drive according to claim 16, wherein said drive further comprises:
a main buffer for temporarily storing data to be transmitted to an external device or received therefrom; and
sub-buffers provided for each of said plurality of magnetic read/write heads for temporarily storing data to be transmitted to said main buffer or received therefrom.
